(19) United States
(12) Patent Application Publication
(10) Pub. No.: US 2013/0221206 A1
(43) Pub. Date: Aug. 29, 2013

(54) Systems and Methods for Conveying Energy

(71) Applicant: Utah State University Research Foundation, (US)

(72) Inventors: Blake Crowther, Preston, ID (US); James C. Peterson, North Logan, UT (US)

(73) Assignee: Utah State University Research Foundation, North Logan, UT (US)

(21) Appl. No.: 13/767,112

(22) Filed: Feb. 14, 2013

Related U.S. Application Data
(60) Provisional application No. 61/604,443, filed on Feb. 28, 2012.

(51) Int. Cl. G01J 1/00

(52) U.S. Cl. CPC G01J 1/00
USPC 250/216

(57) ABSTRACT

Disclosed herein are various energy conveyance systems that are able to convey energy along different optical paths to non-overlapping regions of a sensor. A system can include an objective optics system that collects and focuses energy, and can further include steering optics that are configured to divert an optical path of at least a portion of the energy that is collected via the objective optics system. The steering optics may cause different portions of energy collected via the objective optics system to be delivered as focused field images to non-overlapping or similar sections of a sensor.

### RELATED APPLICATIONS

This application claims priority under 35 U.S.C. §119(e) to U.S. Provisional Patent Application No. 61/604,443, filed Feb. 28, 2012, for Blake Crowther and James C. Peterson, and entitled “SYSTEMS AND METHODS FOR CONVEYING ENERGY,” which is incorporated herein by reference in its entirety.

### STATEMENT REGARDING FEDERALLY SPONSORED RESEARCH OR DEVELOPMENT

The invention was made with support from the U.S. Government under Grant No. NNX09AM71G, which were awarded by the National Aeronautics and Space Administration (NASA). The U.S. Government has certain rights in the invention.

### TECHNICAL FIELD

The present disclosure relates generally to systems and methods for conveying energy, it relates more particularly to conveying energy within a gas-filter correlation radiometer.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1A is a top view of an embodiment of an energy conveyance system that includes a reflective objective optics system, which is schematically shown in cross-section, wherein energy being conveyed through the energy conveyance system is depicted schematically via ray tracing;

FIG. 1B is a front view of the reflective objective optics system of FIG. 1A;

FIG. 1C is a close-up view of the energy conveyance system of FIG. 1a, wherein the sub-beams are focused onto non-overlapping regions of a focal plane array (FPA);

FIG. 2 is a top view of another embodiment of an energy conveyance system that includes a reflective objective optics system, which is schematically shown in cross-section, wherein certain components of the energy conveyance system are at different positions relative to the objective optics system, as compared with FIG. 1, and wherein energy being conveyed through the energy conveyance system is depicted schematically via ray tracing;

FIG. 3 is a top view of another embodiment of an energy conveyance system that includes a reflective objective optics system, which is schematically shown in cross-section, wherein certain components of the energy conveyance system are at different positions relative to the objective optics system, as compared with FIG. 1, and wherein energy being conveyed through the energy conveyance system is depicted schematically via ray tracing;

FIG. 4 is a top view of another embodiment of an energy conveyance system that includes a refractive objective optics system, wherein energy being conveyed through the energy conveyance system is depicted schematically via ray tracing; and

FIG. 5 is a top view of another embodiment of an energy conveyance system that includes a refractive objective optics system, wherein energy being conveyed through the energy conveyance system is depicted schematically via ray tracing.

### DETAILED DESCRIPTION

Disclosed herein are various embodiments of energy conveyance systems that are configured to convey energy along different optical paths. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional”, “optionally”, or “or” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

In certain embodiments, an energy conveyance system can include an objective optics system that collects and focuses energy. The energy conveyance system can further include steering optics that are configured to divert an optical path of at least a portion of the energy that is collected via the objective optics system. In some embodiments, the steering optics cause different portions of energy collected via the objective optics system to be delivered as a focused field image to different sections of a sensor. Since sub-beams are separated from a common beam that is delivered to the objective optics system, the sub-beams would normally be delivered as a focused field image to the same location on the sensor, in the absence of the steering optics. The sensor may be of any suitable variety, such as, for example, an array of sensing elements (e.g., charge coupled devices, charge integrating devices, photomultipliers, etc.). In some embodiments, the steering optics comprise one or more optical wedges, which may be positioned before or after the objective optics system.

The disclosure includes a discussion of various devices, systems, and methods for delivering optical energy from a common field of view as a focused field image onto separate or non-overlapping areas of a target by means of steering optics. Some embodiments may be used as gas-filter correlation radiometry (GFCR) systems (i.e., gas-filter correlation radiometers) that can exhibit various improvements over known GFCR systems. In some embodiments, steering optics, such as optical wedges, can be used to ensure that beams of optical energy are delivered to different portions of the target, which may comprise a sensor of any suitable variety.

As briefly mentioned, certain embodiments can be used such as GFCR systems. As is known in the art, GFCR systems have a wide range of uses. For example, such systems can be used in analyzing the gas content or gas properties of a region of interest, a portion of the earth's atmosphere, or other planets. A region of interest may be another planet or a terrestrial location such as a forest, marsh, coastline, lagoon, city, road, highway, landfill, sewage treatment plant, oil field, mine, farm, ranch, or an emissions stack from a ventilation system, factory, or a power plant. The systems may be positioned or mounted on the ground, a building, vehicle, aircraft, or be satellite-based. GFCR systems operate on the principle that different gases absorb electromagnetic energy at different frequencies. A GFCR system can pass different portions of electromagnetic energy from a given source (e.g., reflected light from a surface or transmitted through a region of interest, light produced in a lab setting, or other radiation from a star or a planet) along different optical paths so as to obtain separate readings from which properties of the source or region of interest may be determined. For example, the system may take measurements of electromagnetic energy that has passed through a vacuum-filled cell, and may also take measurements of electromagnetic energy that has passed through a cell filled with a known concentration of a gas of interest. The differences between the first and second sets of measurements can be used to determine the desired properties of the source or region of interest. Such GFCR systems generally use a beam splitter to obtain the different portions of electromagnetic energy from a common source so as to thereby ensure that the comparison of the separate beams is meaningful.

Systems and methods disclosed herein can exhibit improvements over known GFCR systems. For example, in various embodiments, the systems can allow for simpler, more compact, or more economical designs. These or other advantages of the systems will be apparent from the discussion that follows.

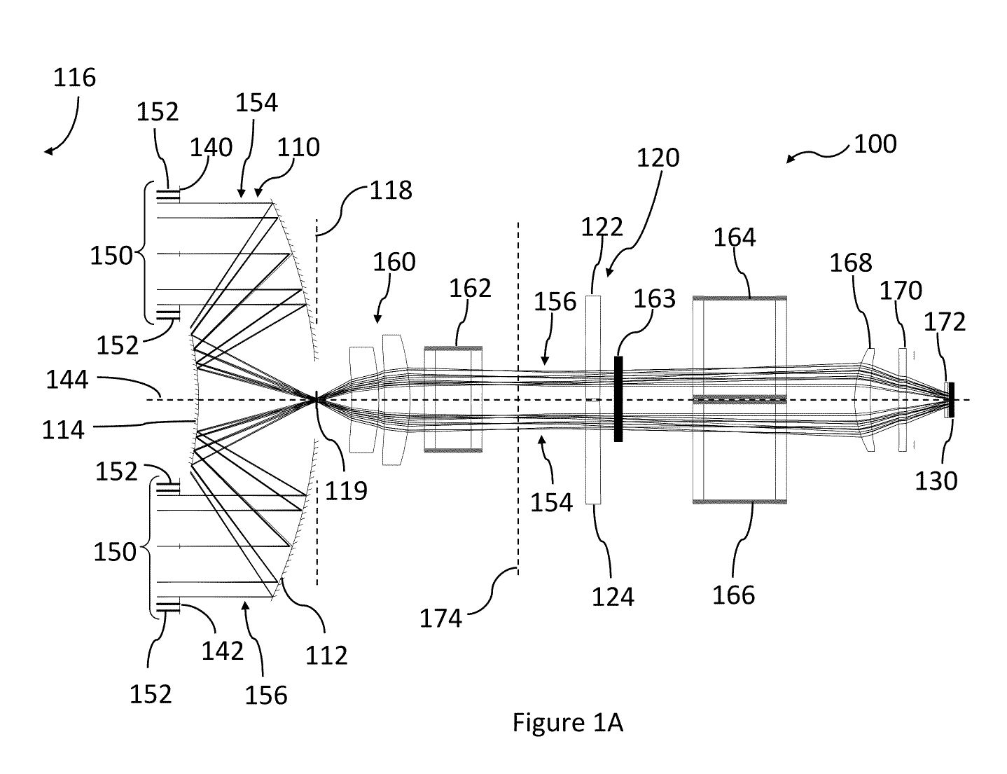

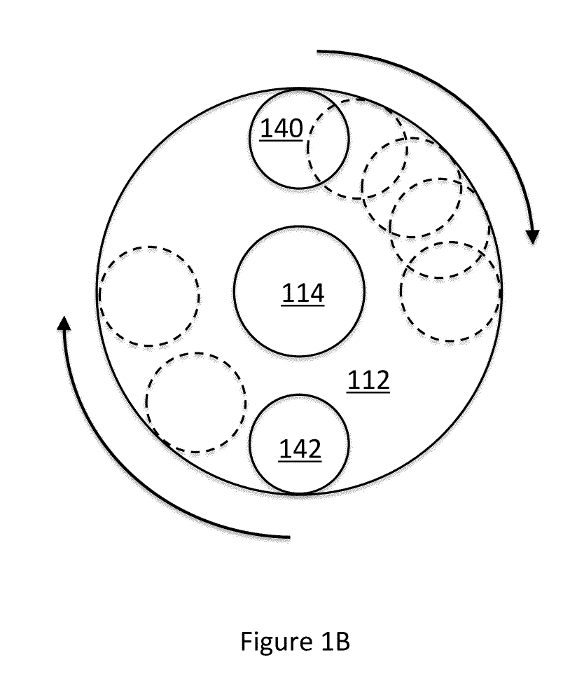

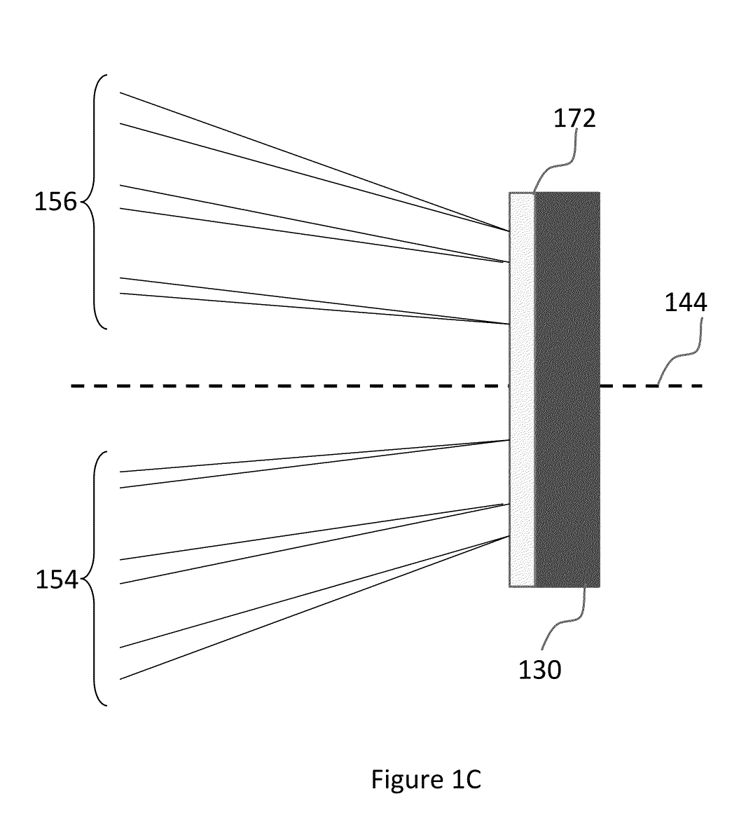

FIG. 1A illustrates an embodiment of an energy conveyance system 100. As previously noted, one context for which the energy conveyance system 100 is particularly well-suited is gas-filter correlation radiometry (GFCR), although other suitable contexts are also possible. Accordingly, the following discussion focuses on a non-limiting implementation of the energy conveyance system 100 in the GFCR context, and thus the system 100 may also be referred to as a GFCR system.

The GFCR system 100 can include an objective optics system 110, which can include one or more optical elements. In the illustrated embodiment, the objective optics system 110 includes a primary mirror 112 and a secondary mirror 114. The objective optics system 110 may also be referred to as a powered objective optics system 110, as it can be configured to focus the electromagnetic energy that it receives. The term “objective” is used in a broad sense, which includes the ordinary meaning of this term. For example, the objective optics system 110 can comprise an objective portion of a telescope, which is configured to gather electromagnetic energy into the telescope. The objective optics system 110 is configured to receive electromagnetic energy and is further configured to focus the electromagnetic energy. In particular, the objective optics system 110 can have a field of view 116, and can be configured to form an image of the field of view 116 at a focal plane 118. In some embodiments, the system 100 can include a field stop 119, which can be positioned at the focal plane 118.

As used herein, the terms “optics,” “optical,” and the like are used in a broad sense. These terms are not intended to limit the functionality of the components or features they describe to operation within the visible spectrum. Rather, various embodiments are configured for use in any suitable portion of the electromagnetic spectrum, such as the visible or infrared portions of the electromagnetic spectrum.

Additionally, the term “optically” may be used in reference to an optical path traversed by electromagnetic energy through the conveyance system 100. For example, it is possible for a first component of the system 100 to be “optically between” a second and a third component of the system 100 where the electromagnetic energy passes through the second component, the first component, and eventually the third component, even if the first component is not physically situated between the second and third components.

The conveyance system 100 further includes steering optics 120, which are configured to divert the optical path of one or more beams of electromagnetic energy. The steering optics 120 can comprise any suitable optical instrument or instruments that are configured to divert the optical path of a beam of electromagnetic energy. In some embodiments, it may be desirable for the steering optics 120 to create the diversion to the optical path without, or without substantially, otherwise influencing the properties of the beam (such as the beam's shape, content, intensity, etc.). In the illustrated embodiment, the steering optics 120 comprise a first optical wedge 122 and a second optical wedge 124. The optical wedges 122 and 124 can comprise any suitable material. For example, in some embodiments, the wedges 122 and 124 may comprise germanium, which has a relatively large index of refraction and thus may be capable of effecting displacement of an optical path via a relatively mildly angled surface (e.g., no greater than about 0.25, 0.5, 1.0, or 2.0 degrees). In the illustrated embodiment, the wedges 122 and 124 are positioned so as to maximize the displacement of two optical paths relative to each other. For example, in one embodiment, each wedge, 122 and 124, defines a surface angle of about 0.5 degrees relative to a plane that is perpendicular to an optical axis 144 of the system 100, and the wedges 122, 124 can be oriented such that the angled surfaces the wedges 122 and 124 define an angle of about 1.0 degrees relative to each other.

The conveyance system further includes a sensor 130 of any suitable variety. In various embodiments, the sensor 130 can comprise an array of sensing elements (not shown). The array can extend in two dimensions, and may define a substantially planar arrangement of the sensing elements. For example, the sensor 130 may comprise a focal plane array. The sensing elements may comprise, for example, charge-coupled devices (CODs), charge integrating devices (CIDs), photomultipliers, or the like. In some embodiments, the sensor 130 comprises a single focal plane array, such that different beams of energy can be delivered as a focused field image to different, non-overlapping sections of the focal plane array, and each section of the focal plane array can perform measurements or other suitable actions on the separate beams of energy. In other embodiments, the sensor 130 may comprise two or more focal plane arrays, which may be positioned side-by-side. Each focal plane array may be positioned so as to receive a separate beam of energy or focused field image. In either case, it can be desirable for one beam of energy to be separate from, or not overlap, another beam of energy so that the properties of the beams can be analyzed separately.

As previously discussed, in GFCR procedures, it can be desirable to use separate beams of energy, which may originate from a common source or region of interest, to form the same image on non-overlapping regions of an FPA. The separate beams of energy may also be detected using two or more separate detectors. The separate beams of energy may also be detected using a detector with only two photo-sensitive regions or multiple photo-sensitive regions as is done with a focal plane array. The separate beams can be passed along different optical paths and through different media (e.g., a reference gas or a vacuum) so as to allow for comparison of the properties of the beams after they have passed along the paths. Whereas known GFCR systems generally use a beam splitter to obtain the separate beams of energy from the common source, embodiments disclosed herein can provide beams of energy from a common source without the use of a beam splitter.

With reference to FIGS. 1A and 1B, the system 100 can further include a plurality of apertures. The illustrated embodiment includes two apertures 140 and 142, which are positioned in front of the objective optics system 110. FIG. 1B illustrates the objective optics system of FIG. 1A from the front. Any desired number of apertures 140 and 142 may be used, and each may provide a separate beam of electromagnetic energy for delivery to the sensor 130. Although embodiments depicted in FIGS. 1-5 are discussed with respect to two apertures 140 and 142, and two corresponding beams of energy, it is to be understood that additional apertures and additional corresponding components can be used to deliver additional beams of energy to the sensor, as desired.

Referring back to FIG. 1A, in the illustrated embodiment, the apertures 140 and 142 are positioned diametrically opposite from one another. Stated otherwise, the aperture 140 is angularly spaced from the aperture 142 about the optical axis 144 of the system 100 by 180 degrees. In other embodiments, one aperture may be angularly spaced from another by about 10, 15, 20, 30, 45, 60, 90, 120, 135, or 150 degrees. Various embodiments include two or more, three or more, or four or more apertures, as well as corresponding optical components positioned along optical paths that pass through each such aperture. With two, three, or four or more apertures, the apertures may be arranged in a circular pattern around the optical axis 144.

With continued reference to FIG. 1A, a beam 150 of electromagnetic energy that is within the field of view 116 can be directed to the objective optics system 110. The beam 150 can originate or be reflected from any suitable object and transmitted through a region of interest or target of which observation is desired. In certain instances, the beam 150 may be substantially collimated. For example, in some instances, the beam 150 may originate from a very distant object such that the electromagnetic radiation is substantially non-divergent. Only an annular segment of the beam 150 is depicted in FIG. 1A (in schematic cross-section).

The apertures 140 and 142 can be positioned so as to permit portions of the beam 150 of electromagnetic energy to pass through them and so as to block other portions (the blocked portions are designated at 152) of the beam 150. The apertures 140 and 142 thus may separate the beam 150 into smaller beams of energy, or sub-beams 154 and 156. FIG. 1A illustrates the sub-beams 154 and 156 focused at the focal plane 118 and crossed over the optical axis 144. Thereafter, the sub-beams 154 and 156 can pass through a collimating lens system 160 so as to be collimated thereby. In some embodiments, the sub-beams 154 and 156 can pass through a test cell 162, which can include one or more gases and can be configured to simulate an atmospheric system, such as for bench test. In other embodiments, the system 100 may not include the test cell 162. The sub-beams 154 and 156 can then pass through the steering optics 120, such that one or more of the sub-beams 154 and 156 is diverted from its columnar optical path. The sub-beams 154 and 156 can then pass through any suitable testing equipment, such as a warm filter 163 and one or more gas cells 164 and 166, respectively. The sub-beams 154 and 156 may thereafter be focused via a focusing system 168 (which may include one or more lenses) onto separate, non-overlapping regions of the sensor 130. Upon arrival on the sensor 130, the sub-beams 154 and 156 may be focused field images. In some embodiments, after having passed through the focusing system 168, the sub-beams may further pass into a cooled Dewar through a Dewar window 170, and may pass through a cold filter 172 prior to impinging on the sensor 130.

A variety of alternative arrangements are possible from that specifically depicted in FIG. 1A. Any suitable rearrangement of the various components along the optical paths of the beam 150 or the sub-beams 154 and 156 is contemplated. For example, in the illustrated embodiment, the apertures 140 and 142 are positioned optically before the objective optics system 110. However, in other embodiments, the apertures 140 and 142 may be positioned optically after the objective optics system 110. In embodiments, the beam 150 may be permitted to enter the objective optics system 110 unrestrained, and may then pass through the collimating optics 160 so as to be re-collimated thereby. The apertures 140 and 142 can be positioned at the plane 174 so as to block portions of the re-collimated beam 150 and permit the sub-beams 154 and 156 to pass through them. The sub-beams 154 and 156 can then pass through the steering optics 120, the filter 163, the one or more gas cells 164 and 166 (respectively), the focusing system 168, the Dewar window 170, or the filter 172, where such are present, and then onto the sensor 130.

In other or further embodiments, the steering optics 120 may be positioned optically before the objective optics system 110. Additionally, as previously discussed the steering optics 120 may include only a single optical wedge, and may be positioned so as to divert only one of the sub-beams 154.

As shown in FIG. 1C, in embodiments, the non-diverted sub-beam 156 can be delivered to the sensor 130 along the optical axis 144, whereas the diverted sub-beam 154 may impinge on the sensor 130 at a position that is spaced from the optical axis 144 and does not overlap the image formed by the focused, non-diverted sub-beam 156.

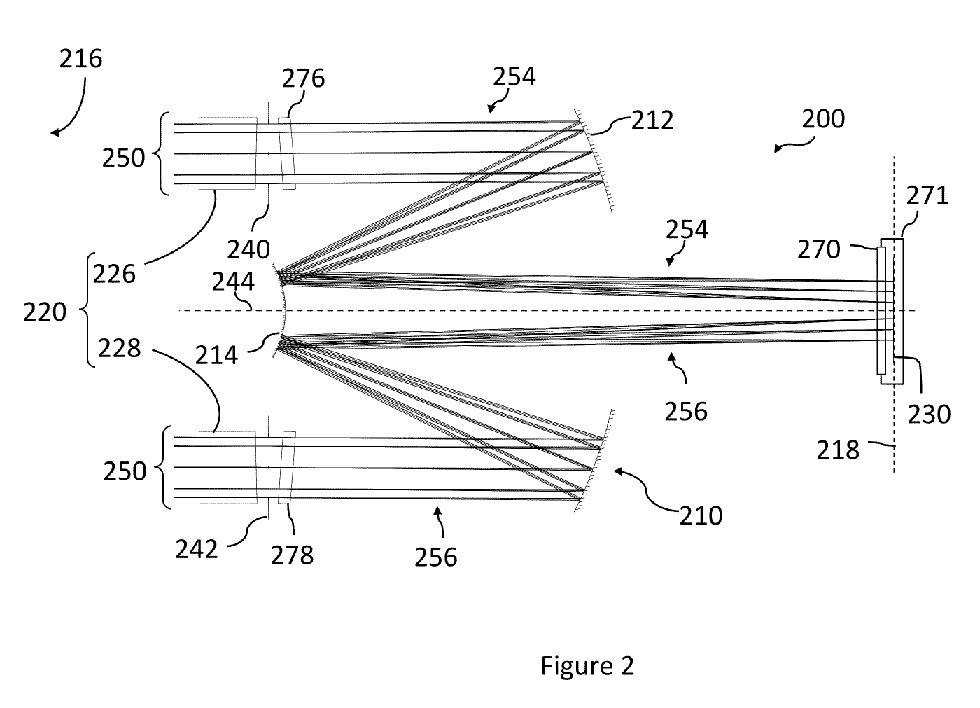

Hereafter, the embodiment of FIG. 1A is again described, with a few additional details, although some of the concepts previously discussed may again be mentioned. Thereafter additional embodiments are described with respect to FIGS. 2-5. Various embodiments of energy conveyance systems can include different components (e.g., a refractive objective optics system), or components that are arranged in different orders from, the embodiment depicted in FIG. 1.

With reference to FIG. 1A, in some implementations, electromagnetic energy can be received by the system 100 from a distant source or region of interest, such that the primary beam 150 is collimated, e.g., rays of optical energy within the beam are parallel to each other. In certain embodiments, a diameter of each aperture 140 and 142 is much smaller than a diameter of the primary mirror 112. For example, in various embodiments, a diameter of one or more of the apertures 140 and 142 is no greater than about ⅓, ¼, ⅕, or 1/10 the diameter of the primary mirror 112.

In the illustrated embodiment, the primary mirror 112 reflects the sub-beams 154 and 156 to the secondary mirror 114, such that the mirrors 112 and 114 focus the sub-beams 154 and 156 at the focal plane 118. In embodiments, both of the sub-beams 154 and 156 are isolated from the same primary beam 150, which is gathered from the field of view 116 of the objective optics system 110. Accordingly, the field of view of each sub-beam 154 and 156 is identical to that of the other.

In the illustrated embodiment, the collimating system 160 includes two lenses. Any other suitable arrangement is possible for the collimating system 160, where used.

In embodiments, the test cell 162 contains a gas that simulates the atmosphere of a region of interest where the system 100 may be used. The test cell 162 thus may be useful in laboratory settings or for configuration of the GFCR system 100. In some implementations, the electromagnetic energy will have passed through an atmosphere before it is received into the system 100. In certain of such embodiments, the test cell 162 is not utilized.

As previously discussed, after passing through the optical wedges 122, the optical beams may optionally be passed through a filter 163, which may be at room temperature or may otherwise be warmer than other filters of the system 100. In some embodiments, the filter 163 is a spectral filter or band pass filter, which can restrict the electromagnetic energy that passes through it to frequencies in accordance with design objectives or requirements, such as frequencies at which one or more gases of interest is known to absorb energy. In other or further embodiments, the filter 163 can include a high pass, low pass, band stop, cold, warm, or notch filter. In some embodiments, the filter 172 may also comprise one or more of a band pass, high pass, low pass, band stop, warm, cold, or notch filter.

In embodiments, one of the gas cells 164 or 166 comprises a vacuum cell. In other or further embodiments, one or more of the gas cells 164 or 166 contain one or more gases of interest (e.g., in a known concentration).

In some embodiments, the focusing system 168 comprises a single lens of any suitable variety. The lens may be formed of any desired material (e.g., zinc selenide).

In some implementations, at room temperature, background noise can dominate over the optical energy passing through the system 100. Accordingly, it may be desirable to place the sensor 130 in a vacuum cell (not shown) and cool the detector. In some embodiments, the sensor 130 may be cooled to the boiling point of liquid nitrogen (i.e., 77 Kelvin). In other embodiments, a warmer or colder temperature may be selected. Other elements, such as the filter 174, may also be included inside the vacuum cell. Where elements are contained within the vacuum cell, the electromagnetic energy can pass through the Dewar window 170 into the cell. The Dewar window thus can desirably be transparent to the electromagnetic energy of interest.

In some implementations, the sensor 130 may be positioned at the pupil image of the sub-beams 154 and 156. Certain of such implementations may be advantageous where the far-field radiance requires homogenization of the detected energy. In other implementations, the sensor 130 is positioned so as to receive a far field image. Certain of such implementations may be advantageous where it is desirable for the object radiance to be preserved in the image. In either case, in some embodiments, having passed through the steering optics, the sub-beams 154 and 156 can arrive as a focused field image at two distinct locations on the sensor 130 and may not overlap. Alternatively, a predetermined portion of the beams 154 and 156 may overlap at the sensor 130. In either case, at least a portion of each of the sub-beams 154 and 156 is delivered to separate or non-overlapping portions of the sensor 130. In still other embodiments, an entirety of the sub-beams 154 and 156 can overlap at the sensor 130.

Any suitable sensor 130 may be used, and any suitable measurements or calculations may be possible thereby. For example, in embodiments, the sensor 130 comprises a two-dimensional array of sensing elements that each counts the number of photons received thereat. The sensor 130 can output a measurement value for each sensing element. In some implementations, the measurements from the sensing elements that receive any portion of a sub-beam 154 and 156 may be summed to create a single value for that beam. A relative difference between the value for each sub-beam 154 and 156 may be computed in any suitable manner known in the art. In other embodiments, the sensor 130 may comprise two or more separate detectors, each of which may comprise one or more sensing elements. The relative differences can be computed directly from the value output from each of the separate detectors.

In some applications, it may be desirable to dynamically adjust the position at which one or more of the sub-beams 154 and 156 impinge on the sensor 130. In some embodiments, dynamic adjustment may be made by rotating one or more of the optical wedges 122 and 124. Any suitable device or technique may be used to rotate the wedges 122 and 124 (e.g., a motor), which may be controlled by a system controller (not shown). In some embodiments, one or more of the optical wedges 122 and 124 are rotated about axes that are parallel to the optical axis 144. As each optical wedge 122 and 124 is rotated, each sub-beam 154 and 156, respectively, can traverse a closed-loop path (e.g., a circular path) on the sensor 130, and thereby impinge upon different sensing elements in a planar array. In embodiments, the rotation may be substantially continuous. In other embodiments, the rotation may be effected between measuring events, and the optical wedges 122 and 124 may be motionless relative to other components during measuring events. As previously discussed, since both sub-beams 154 and 156 are separated from a common beam 150 that is delivered to the objective optics system 110, the sub-beams would normally be delivered to the same location on the sensor 130, in the absence of the optical wedges 122 and 124. Accordingly, the optical wedges 122 and 124 are used to direct the sub-beams 154 and 156 to a desired position on the sensor 130. In some embodiments, dynamic movement of one or more optical wedges 122 and 124 can be used to selectively cause the sub-beams 154 and 156 to overlap at the sensor 130. For example, in some implementations, the energy of the beams can be measured separately when the sub-beams 154 and 156 impinge on different portions of the sensor 130, and the sum or total energy can be measured when the sub-beams 154 and 156 are combined at the same location on the sensor 130.

In certain implementations, the sub-beams 154 and 156 may be said to self-align relative to the sensor 130, as each sub-beam 154 and 156 is drawn from the same field of view with respect to a single objective optics system 110. Stated otherwise, the system 100 can avoid complicated alignment and conveyance techniques, as the sub-beams 154 and 156 naturally follow inverse, complementary, or offset paths relative to one another through the system 100, which would ultimately terminate at the same position on the sensor 130, but for the presence of the steering optics 120. In some implementations, the system 100 can be devoid of a beam splitter for forming two energy beams from the same energy source or can omit complicated devices for conveying energy through the system (e.g., waveguides, such as optical fibers, which can have difficult coupling or decoupling issues of their own). The system 100 can avoid the need to carefully align optical elements, which may be necessary in some GFCR systems. In various implementations, the system 100 can reduce errors or inaccuracies (e.g., those that result from misaligned elements) or can reduce bulk (e.g., by the elimination of various optical components) for a more compact design. Other embodiments similar to the ones disclosed can be used in any application requiring multiple, self-aligned, optical beams with the focal points offset from one another. A target other than a detector array or sensor 130 may be desired in some embodiments.

Although the embodiment disclosed in FIG. 1 is directed to a system 100 in which a single beam 150 is separated, or reduced, to two sub-beams 154 and 156, the system 100 may also be used in situations where multiple separate beams are delivered to the objective optics system 100. For example, in some embodiments, separate collimated beams 154 and 156 from different sources may be delivered to the objective optics system 100. In certain of such embodiments, the apertures 140 and 142 may be omitted.

FIG. 2 illustrates another embodiment of an energy conveyance system 200, which may be used in a GFCR context. The energy conveyance system 100, and various components thereof, can resemble energy conveyance system 100 and components thereof, described above in certain respects. Accordingly, like features are designated with like reference numerals, with the leading digits incremented to “2.” Relevant disclosure set forth above regarding similarly identified features may not be repeated hereafter. Moreover, specific features of the energy conveyance system 200 may not be shown or identified by a reference numeral in the drawings or specifically discussed in the written description that follows. However, such features may clearly be the same, or substantially the same, as features depicted in other embodiments or described with respect to such embodiments. Accordingly, the relevant descriptions of such features apply equally to the features of the energy conveyance system 200. Any suitable combination of the features and variations of the same described with respect to the energy conveyance system 100 can be employed with the energy conveyance system 200, and vice versa. This pattern of disclosure applies equally to further embodiments depicted in subsequent figures and described hereafter, for which leading digits may likewise be incremented.

The energy conveyance system 200 includes an objective optics system 210, which includes a primary mirror 212 and a secondary mirror 214. The system 200 further includes steering optics 220. In the illustrated embodiment, the steering optics 220 includes a first steering assembly 226 and a second steering assembly 228. Each steering assembly 226 and 228 can include an optical wedge (such as the optical wedges 122 and 124 discussed above). Each steering assembly 226 and 228 may also include any suitable filter, gas cell (or vacuum cell), or other optical instrument. In some embodiments, each steering assembly 226 and 228 includes a window, which may be selectively opened or closed to permit energy to pass through, or from, the steering assembly 226 and 228, depending on desired observation conditions. In the illustrated embodiment, the steering assemblies 226 and 228 (and thus the optical wedges contained therein) are positioned optically before or in front of the objective optics system 210, such that energy passes from the steering assemblies 226 and 228 to the objective optics system 210.

The system 200 further includes a pair of filters 276 and 278 of any suitable variety. The system may include a sensor 230, which is positioned within a vacuum cell 271. A Dewar window 270 may be provided in the vacuum cell to permit energy to enter the cell 271 and impinge upon the sensor 230. The system 200 defines an optical axis 244.

In use, an electromagnetic beam 250, which may be collimated, can progress toward the objective optics system 210 from a scene 216. Portions of the beam 250 can pass through the steering assemblies 226 and 228. Depending on whether or not a steering assembly 226 and 228 includes an optical wedge therein, the portion of the beam may exit the steering assembly 226 and 228 along a diverted path. The portions of the beam 250 can continue through the apertures 240 and 242, where the remainder of the beam 250 continues into the objective optics system 210 as sub-beams 254 and 256.

In the illustrated embodiment, the sensor 230 is positioned such that a field of view 216 of the objective optics system 210 is imaged directly onto the sensor 230. In particular, the field of view 216 is imaged at two distinct positions of the sensor 230, one of which is above the optical axis 244 and the other of which is below the optical axis 244. Stated otherwise, the electromagnetic (e.g., infrared or optical) energy constituting each sub-beam 254 and 256, is diverted from its original optical course, such that each sub-beam 254 and 256 is imaged at a position that is spaced from the optical axis 244, rather than along the optical axis, at a focal plane 218 of the objective optics system 210. In the absence of the refracting steering assemblies 226 and 228, which shift the optical path of the sub-beams 254 and 256 upwardly and downwardly, respectively, the sub-beams 254 and 256 would merge and form a unitary image of the field of view 216.

In some embodiments, each steering assembly 226 and 228 includes an optical wedge having a one-degree angle. In certain of such embodiments, a diameter of each aperture can be 15 millimeters. The illustrated embodiment does not include collimating lenses or focusing lenses. Additionally, in the illustrated embodiment, much of the processing of electromagnetic energy is performed prior to formation of the sub-beams 254 and 256. In some embodiments, the system 200 can have a field of view of no greater than about 2.0, 2.5, or 3.0 degrees, although other values are also possible.

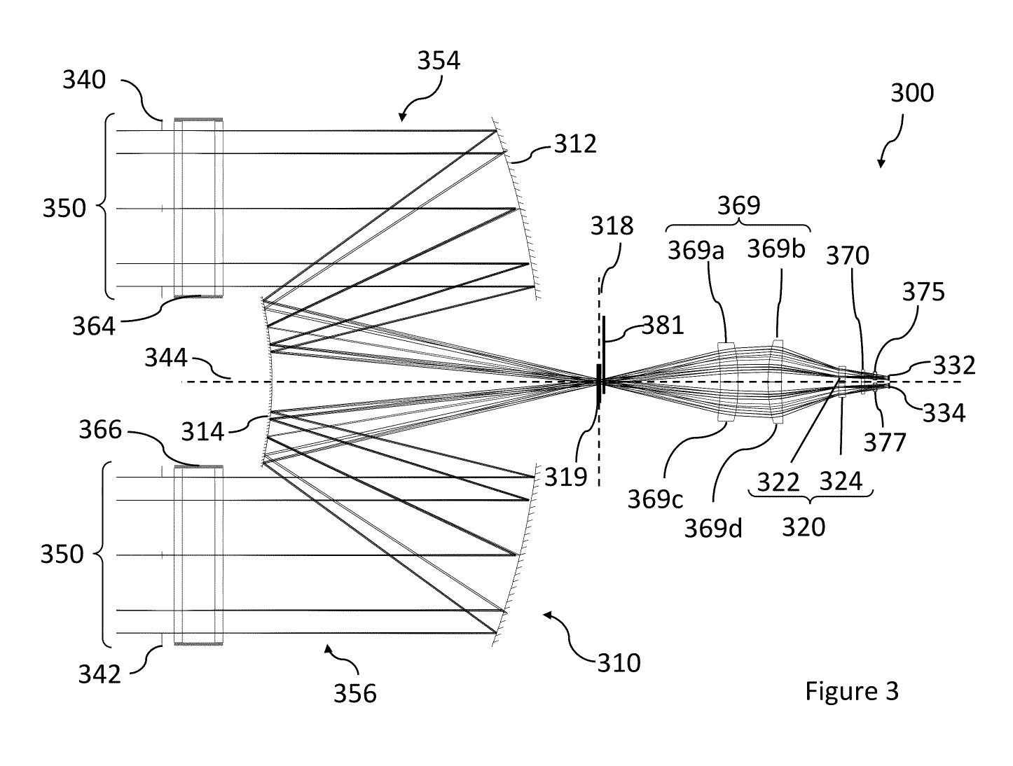

FIG. 3 illustrates another embodiment of an energy conveyance system 300, which can resemble the energy conveyance systems 100 or 200 described above in various respects. The energy conveyance system 300 includes an objective optics system 310, which includes a primary mirror 312 and a secondary mirror 314. The system 300 further includes steering optics 320. In the illustrated embodiment, the steering optics 320 includes first and second optical wedges 322 and 324. The optical wedges 322 and 324 are positioned just in front of a Dewar window 370. The Dewar window may be positioned optically in front of cold filters 375 and 377 and separate sensor devices 332 and 334, which are retained within the Dewar for cooling purposes. Accordingly, the wedges 322 and 324 are configured to deviate the optical path of electromagnetic beams at a much later stage before they impinge upon the sensor devices 332 and 334, as compared with the wedges 122 and 124, illustrated in FIG. 1.

The system 300 further includes a pair of gas cells 364 and 366 of any suitable variety, which are positioned optically between apertures 340 and 342 and the objective optics system 310. The system 300 defines an optical axis 344, and the objective optics system 310 defines a focal plane at which a field stop 319 is positioned. The illustrated system 300 further includes an optical chopper 381 of any suitable variety. The illustrated system 300 further includes focusing optics 369 (e.g., 369a, b, c, and d) that are configured to focus separate beams of energy onto the sensors 332 and 334.

In use, an electromagnetic beam 350, which may be collimated, can progress toward the objective optics system 310. Portions of the beam 350 can pass through the apertures 340 and 342 as sub-beams 354 and 356 in manners substantially similar to those described above with respect to FIG. 1. In some embodiments, the optical chopper 381 can be used to modulate the beam so that coherent rectification or detection may be used in order to reduce the noise in the system. In some embodiments, the system 300 can have a field of view of no greater than about 0.25, 0.5, or 1.0 degree, although other values are also possible.

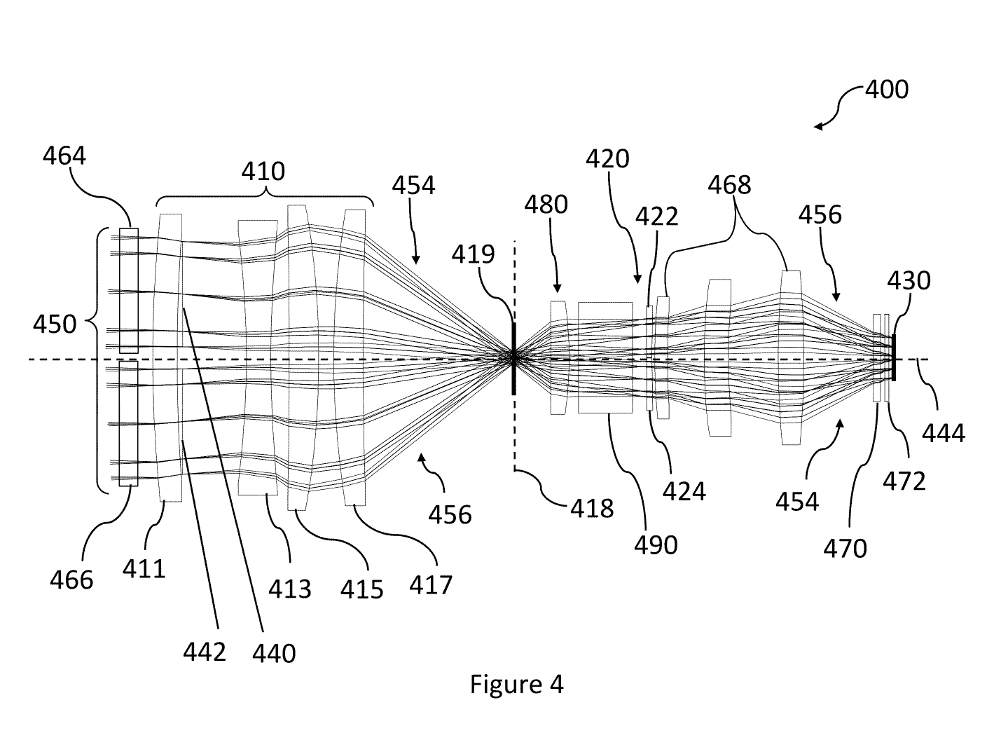

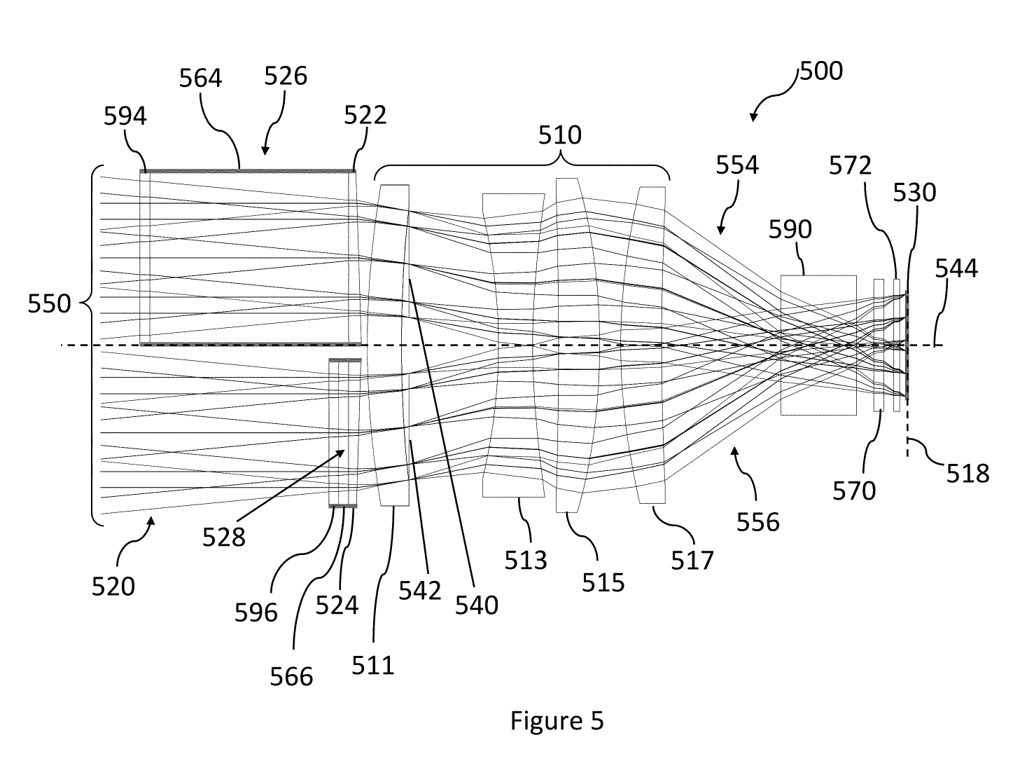

In some embodiments, an objective optics system may include one or more lenses instead of, or in addition to, one or more mirrors. Various embodiments of energy conveyance systems that include refractive lens-based objective optics systems are discussed below with respect to FIGS. 4 and 5. In some implementations, lens-based systems may have an improved or enlarged field of view, as compared with certain mirror-based systems. However, in some implementations, lens-based systems may provide a smaller beam separation, as compared with certain mirror-bases systems.

FIG. 4 illustrates another embodiment of an energy conveyance system 400, which can resemble in various respects the energy conveyance systems 100, 200, or 300 described above. The energy conveyance system 400 includes an objective optics system 410, which can include one or more refracting lenses 411, 413, 415, or 417. The illustrated embodiment includes four aspheric lenses, with the first lens 411 being a positive meniscus lens, the second lens 413 being a biconcave lens, and each of the third and fourth lenses 415 and 417 being plano-convex lenses. Any suitable arrangement of lenses is possible, and the objective optics system 410 can be configured to gather electromagnetic energy (e.g., optical, infrared, or UV energy) and focus the same. In the illustrated embodiment, the objective optics system 410 defines a focal plane 418, and a field stop 419 is positioned at the focal plane 418.

The system 400 further includes a collimating lens system 480, which in the illustrated embodiment comprises a single plano-convex lens. The system 400 also includes an etalon 490, steering optics 420 (which includes optical wedges 422 and 424), focusing or reimaging optics 468, a window 470, a cooled filter 472, and a sensor 430, all of which can be aligned along, or adjacent to, an optical axis 444 of the system 400. Apertures 440 and 442 may also be provided so as to reduce an incoming beam 450 of electromagnetic energy into sub-beams 454 and 456 thereof. One or more gas cells 464 and 466 of any suitable variety may be positioned at any suitable position along the optical path of the beam 450 (or portions thereof). In the illustrated embodiment, each of the gas cells 464 and 466 is positioned in front of the objective optics system 410, although other positions are also possible.

The etalon 490 is configured to provide extremely narrow spectral filtering that can be tuned in operation. One embodiment of a tunable etalon that could be used is a liquid crystal Fabry-Perot (LCFP) etalon, although other types of etalons are also possible. In some embodiments, the system 400 can have a field of view of no greater than about 2.0, 2.5, or 3.0 degrees, although other values are also possible.

FIG. 5 illustrates another embodiment of an energy conveyance system 500, which can resemble in various respects the energy conveyance systems 100, 200, 300, or particularly 400. The energy conveyance system 500 includes an objective optics system 510, which can include one or more refracting lenses 511, 513, 515, or 517. As with the objective optics system 410, the illustrated embodiment includes four aspheric lenses, with the first lens 511 being a positive meniscus lens, the second lens 513 being a biconcave lens, and each of the third and fourth lenses 515 and 517 being plano-convex lenses. Any suitable arrangement of lenses is possible, and the objective optics system 510 can be configured to gather electromagnetic energy (e.g., optical, infrared, or UV energy) and focus the same. In the illustrated embodiment, the objective optics system 510 defines a focal plane 518, with a sensor 530 positioned at the focal plane 518 (similar to the system 200 described above with respect to FIG. 2).

The energy conveyance system 500 can include steering optics 520. In the illustrated embodiment, the steering optics 520 includes a first steering assembly 526 and a second steering assembly 528. Each steering assembly 526 and 528 can include an optical wedge, 522 and 524 (similar to the optical wedges 122 and 124 discussed above). Each steering assembly 526 and 528 may also include any suitable filter, gas cell 564, vacuum cell 566, or optical instrument. In some embodiments, each steering assembly 526 and 528 includes a window 594 and 596, which may be selectively opened or closed to permit energy to pass through, or from, the steering assembly 526 and 528 depending desired test conditions. In the illustrated embodiment, the steering assemblies 526 and 528 (and thus the optical wedges 522 and 524 contained therein) are positioned optically before or in front of the objective optics system 510, such that energy passes from the steering assemblies 526 and 528 to the objective optics system 510.

Apertures 540 and 542 may also be provided so as to reduce an incoming beam 550 of electromagnetic energy into sub-beams 554 and 556 thereof. Unlike the system 200 illustrated in FIG. 2, the steering assemblies 526 and 528 are configured to divert the optical paths of the sub-beams 554 and 556 such that each sub-beam traverses an optical axis 544 of the system so as to be imaged on opposite sides of the optical axis. The imaging takes place at a focal plane 518 at which a sensor 530 is positioned. In the illustrated embodiment, the vacuum cell 566 is shorter than the gas cell 564. In some embodiments, the system 500 can have a field of view of no greater than about 5, 10, or 15 degrees, although other values are also possible.

As with other embodiments, the illustrated embodiment of the system 500 includes an etalon 590, a window 570, a cooled filter 572, and a sensor 530, each of which can be aligned along an optical axis 544 of the system 500.

Changes may be made to the details of the above-described embodiments without departing from the underlying principles presented herein. For example, any suitable combination of various embodiments, or the features thereof, is contemplated.

Any methods disclosed herein comprise one or more steps or actions for performing the described method. The method steps or actions may be interchanged with one another. In other words, unless a specific order of steps or actions is required for proper operation of the embodiment, the order or use of specific steps or actions may be modified.

References to approximations are made throughout this specification, such as by use of the terms “about” or “approximately.” For each such reference, it is to be understood that, in some embodiments, the value, feature, or characteristic may be specified without approximation. For example, where qualifiers such as “about,” “substantially,” and “generally” are used, these terms include within their scope the qualified words in the absence of their qualifiers. For example, where the term “substantially planar” is recited with respect to a feature, it is understood that in further embodiments, the feature can have a precisely planar orientation.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment. The terms “system” or “assembly” should not be construed to require more than a single object, although certain systems and assemblies may include multiple component parts.

Similarly, in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. Recitation in the claims of the term “first” with respect to a feature or element does not necessarily imply the existence of a second or additional such feature or element.

We claim:

1. A system for collecting and conveying energy, the system comprising:
an objective optics system;
a first aperture positioned to convey a first portion of energy through the first aperture and then onto a first portion of the objective optics system;
a second aperture positioned to convey a second portion of energy to pass through the second aperture and then onto a second portion of the objective optics system;
a sensor; and
steering optics configured to divert the first and second portions of energy as focused images onto non-overlapping regions of the sensor.

2. The system of claim 1, wherein the steering optics comprise one or more optical wedges.

3. The system of claim 2, wherein a second optical wedge is configured to divert the second portion of energy.

4. The system of claim 1, wherein:
the system defines an optical axis;
the first aperture is positioned on a first side of the optical axis; and
the second aperture is positioned on a second side of the optical axis that is opposite from the first side.

5. The system of claim 1, wherein the sensor comprises a digital focal plane array.

6. The system of claim 1, wherein the sensor is positioned at a far-field focal plane of the system.

7. The system of claim 1, wherein the sensor is positioned to receive a pupil image of a field of view of the objective optics system.

8. The system of claim 1, wherein the steering optics are dynamically adjustable to position the first portion of energy to a non-overlapping region of the sensor.

9. The system of claim 1, further comprising one or more filters configured for use in gas-filter correlation radiometry.

10. The system of claim 9, wherein at least one of the one or more filters comprises a gas-filled cell.

11. The system of claim 1, wherein the objective optics system is configured to project an image of a portion of a field of view onto the sensor.

12. The system of claim 1, further comprising an optical chopper configured to modulate the first and second portions of energy.

13. The system of claim 1, further comprising an etalon configured to provide narrow spectral filtering of at least one of the first and second portions of energy.

14. The system of claim 13, wherein the etalon filter can be tuned in operation.

15. A method for collecting and conveying energy, the method comprising:
passing a first portion of energy through a first aperture onto a first portion of an objective optics system;
passing a second portion of energy through a second aperture onto a second portion of the objective optics system;
diverting the first and second portions of energy as focused images onto non-overlapping regions of a sensor.

16. The method of claim 15, wherein diverting the first portion of energy comprises passing the first portion of energy through a first optical wedge.

17. The method of claim 16, further comprising diverting the second portion of energy through a second optical wedge.

18. The method of claim 15, wherein the first and second portions of energy are subsets of a beam of energy that is directed toward the objective optics system.
